(19) United States
(12) Patent Application Publication
(10) Pub. No.: US 2005/0038839 A1
(43) Pub. Date: Feb. 17, 2005

(54) Method and system for evaluating a set of normalizing features and for iteratively refining a set of normalizing features

(76) Inventors: Srinka Ghosh, San Francisco, CA (US); Mark Hartnett, San Jose, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/639,184

(22) Filed: Aug. 11, 2003

(51) Int. Cl. G06F 7/00

(52) U.S. Cl. 708/205

(57) ABSTRACT

A method and system for evaluating the quality of normalizing feature sets used in normalizing two or more data sets obtained from microarrays, and for iteratively normalizing two or more data sets. In a described implementation, a rank-consistency threshold employed in selection and/or refinement of invariant features from the one or more data sets varied, as needed, during each iteration of an iterative normalization method, so that the iterative normalization converges on a set of invariant features for which a metric Φ falls below a threshold value. The metric Φ may be calculated as the percentage of selected invariant features, or normalizing features, that are differentially expressed in one or more data sets, to a specified level of significance. For a perfect set of invariant, or normalizing, features, the metric Φ has the value of 0. Φ-metric values of increasing magnitude correspond to normalizing feature sets of decreasing utility for normalization.

### TECHNICAL FIELD

The present invention relates to normalization of data sets derived from microarray experiments, and, in particular, to a method and system for evaluating the quality of a normalizing feature set and for iteratively refining a normalizing feature set used for microarray-data-set normalization.

### BACKGROUND OF THE INVENTION

One embodiment of the present invention is related to processing of scanned, digital images of microarrays in order to extract signal data for features of the microarray. A general background of molecular-array technology is first provided, in this section, to facilitate discussion of various embodiments of the present invention, in following subsections.

Array technologies have gained prominence in biological research and are likely to become important and widely used diagnostic tools in the healthcare industry. Currently, microarray techniques are most often used to determine the concentrations of particular nucleic-acid polymers in complex sample solutions. Molecular-array-based analytical techniques are not, however, restricted to analysis of nucleic acid solutions, but may be employed to analyze complex solutions of any type of molecule that can be optically or radiometrically scanned and that can bind with high specificity to complementary molecules synthesized within, or bound to, discrete features on the surface of an array. Because arrays are widely used for analysis of nucleic acid samples, the following background information on arrays is introduced in the context of analysis of nucleic acid solutions following a brief background of nucleic acid chemistry.

Deoxyribonucleic acid (“DNA”) and ribonucleic acid (“RNA”) are linear polymers, each synthesized from four different types of subunit molecules. The subunit molecules for DNA include: (1) deoxy-adenosine, abbreviated “A,” a purine nucleoside; (2) deoxy-thymidine, abbreviated “T,” a pyrimidine nucleoside; (3) deoxy-cytosine, abbreviated “C,” a pyrimidine nucleoside; and (4) deoxy-guanosine, abbreviated “G,” a purine nucleoside. The subunit molecules for RNA include: (1) adenosine, abbreviated “A,” a purine nucleoside; (2) uracil, abbreviated “U,” a pyrimidine nucleoside; (3) cytosine, abbreviated “C,” a pyrimidine nucleoside; and (4) guanosine, abbreviated “G,” a purine nucleoside. FIG. 1 illustrates a short DNA polymer 100, called an oligomer, composed of the following subunits: (1) deoxy-adenosine 102; (2) deoxy-thymidine 104; (3) deoxy-cytosine 106; and (4) deoxy-guanosine 108. When phosphorylated, subunits of DNA and RNA molecules are called “nucleotides” and are linked together through phosphodiester bonds 110-115 to form DNA and RNA polymers. A linear DNA molecule, such as the oligomer shown in FIG. 1, has a 5′ end 118 and a 3′ end 120. A DNA polymer can be chemically characterized by writing, in sequence from the 5′ end to the 3′ end, the single letter abbreviations for the nucleotide subunits that together compose the DNA polymer. For example, the oligomer 100 shown in FIG. 1 can be chemically represented as “ATCG.” A DNA nucleotide comprises a purine or pyrimidine base (e.g. adenine 122 of the deoxy-adenylate nucleotide 102), a deoxy-ribose sugar (e.g. deoxy-ribose 124 of the deoxy-adenylate nucleotide 102), and a phosphate group (e.g. phosphate 126) that links one nucleotide to another nucleotide in the DNA polymer. In RNA polymers, the nucleotides contain ribose sugars rather than deoxy-ribose sugars. In ribose, a hydroxyl group takes the place of the 2′ hydrogen 128 in a DNA nucleotide. RNA polymers contain uridine nucleosides rather than the deoxy-thymidine nucleosides contained in DNA. The pyrimidine base uracil lacks a methyl group (130 in FIG. 1) contained in the pyrimidine base thymine of deoxy-thymidine.

The DNA polymers that contain the organization information for living organisms occur in the nuclei of cells in pairs, forming double-stranded DNA helixes. One polymer of the pair is laid out in a 5′ to 3′ direction, and the other polymer of the pair is laid out in a 3′ to 5′ direction. The two DNA polymers in a double-stranded DNA helix are therefore described as being anti-parallel. The two DNA polymers, or strands, within a double-stranded DNA helix are bound to each other through attractive forces including hydrophobic interactions between stacked purine and pyrimidine bases and hydrogen bonding between purine and pyrimidine bases, the attractive forces emphasized by conformational constraints of DNA polymers. Because of a number of chemical and topographic constraints, double-stranded DNA helices are most stable when deoxy-adenylate subunits of one strand hydrogen bond to deoxy-thymidylate subunits of the other strand, and deoxy-guanylate subunits of one strand hydrogen bond to corresponding deoxy-cytidilate subunits of the other strand.

FIGS. 2A-B illustrates the hydrogen bonding between the purine and pyrimidine bases of two anti-parallel DNA strands. FIG. 2A shows hydrogen bonding between adenine and thymine bases of corresponding adenosine and thymidine subunits, and FIG. 2B shows hydrogen bonding between guanine and cytosine bases of corresponding guanosine and cytosine subunits. Note that there are two hydrogen bonds 202 and 203 in the adenine/thymine base pair, and three hydrogen bonds 204-206 in the guanosine/cytosine base pair, as a result of which GC base pairs contribute greater thermodynamic stability to DNA duplexes than AT base pairs. AT and GC base pairs, illustrated in FIGS. 2A-B, are known as Watson-Crick (“WC”) base pairs.

Two DNA strands linked together by hydrogen bonds forms the familiar helix structure of a double-stranded DNA helix. FIG. 3 illustrates a short section of a DNA double helix 300 comprising a first strand 302 and a second, anti-parallel strand 304. The ribbon-like strands in FIG. 3 represent the deoxyribose and phosphate backbones of the two anti-parallel strands, with hydrogen-bonding purine and pyrimidine base pairs, such as base pair 306, interconnecting the two strands. Deoxy-guanylate subunits of one strand are generally paired with deoxy-cytidilate subunits from the other strand, and deoxy-thymidilate subunits in one strand are generally paired with deoxy-adenylate subunits from the other strand. However, non-WC base pairings may occur within double-stranded DNA.

Double-stranded DNA may be denatured, or converted into single stranded DNA, by changing the ionic strength of the solution containing the double-stranded DNA or by raising the temperature of the solution. Single-stranded DNA polymers may be renatured, or converted back into DNA duplexes, by reversing the denaturing conditions, for example by lowering the temperature of the solution containing complementary single-stranded DNA polymers. During renaturing or hybridization, complementary bases of anti-parallel DNA strands form WC base pairs in a cooperative fashion, leading to reannealing of the DNA duplex. Strictly A-T and G-C complementarity between anti-parallel polymers leads to the greatest thermodynamic stability, but partial complementarity including non-WC base pairing may also occur to produce relatively stable associations between partially-complementary polymers. In general, the longer the regions of consecutive WC base pairing between two nucleic acid polymers, the greater the stability of hybridization between the two polymers under renaturing conditions.

The ability to denature and renature double-stranded DNA has led to the development of many extremely powerful and discriminating assay technologies for identifying the presence of DNA and RNA polymers having particular base sequences or containing particular base subsequences within complex mixtures of different nucleic acid polymers, other biopolymers, and inorganic and organic chemical compounds. One such methodology is the array-based hybridization assay. FIGS. 4-7 illustrate the principle of the array-based hybridization assay. An array (402 in FIG. 4) comprises a substrate upon which a regular pattern of features is prepared by various manufacturing processes. The array 402 in FIG. 4, and in subsequent FIGS. 5-7, has a grid-like 2-dimensional pattern of square features, such as feature 404 shown in the upper left-hand corner of the array. Each feature of the array contains a large number of identical oligonucleotides covalently bound to the surface of the feature. These bound oligonucleotides are known as probes. In general, chemically distinct probes are bound to the different features of an array, so that each feature corresponds to a particular nucleotide sequence. In FIGS. 4-6, the principle of array-based hybridization assays is illustrated with respect to the single feature 404 to which a number of identical probes 405-409 are bound. In practice, each feature of the array contains a high density of such probes but, for the sake of clarity, only a subset of these are shown in FIGS. 4-6.

Once an array has been prepared, the array may be exposed to a sample solution of target DNA or RNA molecules (410-413 in FIG. 4) labeled with fluorophores, chemiluminescent compounds, or radioactive atoms 415-418. Labeled target DNA or RNA hybridizes through base pairing interactions to the complementary probe DNA, synthesized on the surface of the array. FIG. 5 shows a number of such target molecules 502-504 hybridized to complementary probes 505-507, which are in turn bound to the surface of the array 402. Targets, such as labeled DNA molecules 508 and 509, that do not contains nucleotide sequences complementary to any of the probes bound to array surface do not hybridize to generate stable duplexes and, as a result, tend to remain in solution. The sample solution is then rinsed from the surface of the array, washing away any unbound-labeled DNA molecules. In other embodiments, unlabeled target sample is allowed to hybridize with the array first. Typically, such a target sample has been modified with a chemical moiety that will react with a second chemical moiety in subsequent steps. Then, either before or after a wash step, a solution containing the second chemical moiety bound to a label is reacted with the target on the array. After washing, the array is ready for scanning. Biotin and avidin represent an example of a pair of chemical moieties that can be utilized for such steps.

Finally, as shown in FIG. 6, the bound labeled DNA molecules are detected via optical or radiometric scanning. Optical scanning involves exciting labels of bound labeled DNA molecules with electromagnetic radiation of appropriate frequency and detecting fluorescent emissions from the labels, or detecting light emitted from chemiluminescent labels. When radioisotope labels are employed, radiometric scanning can be used to detect the signal emitted from the hybridized features. Additional types of signals are also possible, including electrical signals generated by electrical properties of bound target molecules, magnetic properties of bound target molecules, and other such physical properties of bound target molecules that can produce a detectable signal. Optical, radiometric, or other types of scanning produce an analog or digital representation of the array as shown in FIG. 7, with features to which labeled target molecules are hybridized similar to 706 optically or digitally differentiated from those features to which no labeled DNA molecules are bound. In other words, the analog or digital representation of a scanned array displays positive signals for features to which labeled DNA molecules are hybridized and displays negative features to which no, or an undetectably small number of, labeled DNA molecules are bound. Features displaying positive signals in the analog or digital representation indicate the presence of DNA molecules with complementary nucleotide sequences in the original sample solution. Moreover, the signal intensity produced by a feature is generally related to the amount of labeled DNA bound to the feature, in turn related to the concentration, in the sample to which the array was exposed, of labeled DNA complementary to the oligonucleotide within the feature.

In general, microarray experiments involve collection of two or more data sets. Before the data sets can be used to produce biological or chemical results, they generally need to be normalized, since the ratios between absolute signal intensities measured and the corresponding biological or chemical target concentrations in sample solutions may vary greatly from experiment to experiment, and between signals produced at different wavelengths by different chromophores. A rank-consistency method may be applied to choose, as normalizing features, those features that follow a central tendency within the data sets being normalized. Currently, however, the quality of the normalizing features sets is not easily evaluated, and normalizing feature sets are generally not refined and optimized. A need for a rational method for evaluating normalizing feature sets and refining normalizing feature sets has therefore been recognized.

### SUMMARY OF THE INVENTION

In one embodiment of the present invention, two or more data sets obtained from microarrays are iteratively normalized with a rank-consistency threshold employed in selection of invariant features from the one or more data sets varied, as needed, during each iteration, so that the iterative normailzation converges on a set of invariant features for which a metric Φ falls below a threshold value. In the described embodiment, the metric Φ is calculated as the percentage of selected invariant features, or normalizing features, that are differentially expressed in one or more data sets, to a specified level of significance. For a perfect set of invariant, or normalizing, features, the metric Φ has the value of 0. Φ-metric values of increasing magnitude correspond to normalizing feature sets of decreasing efficiency for normalization.

### BRIEF DESCRIPTION OF THE DRAWINGS

FIG. 1 illustrates a short DNA polymer 100, called an oligomer, composed of the following subunits: (1) deoxy-adenosine 102; (2) deoxy-thymidine 104; (3) deoxy-cytosine 106; and (4) deoxy-guanosine 108.

FIGS. 2A-B illustrate the hydrogen bonding between the purine and pyrimidine bases of two anti-parallel DNA strands.

FIG. 3 illustrates a short section of a DNA double helix 300 comprising a first strand 302 and a second, anti-parallel strand 304.

FIGS. 4-7 illustrate the principle of the array-based hybridization assay.

FIG. 8 illustrates a square region of the surface of a microarray that includes a single feature.

FIGS. 9A-B illustrate two, very small, exemplary data sets produced from a hypothetical two-signal microarray experiment.

FIG. 10 shows a two-dimensional plot of the combined C₁ and C₂ data sets shown in FIGS. 9A-B.

FIGS. 11A-B show a sequential ranking of the features in the C₁ and C₂ data sets, respectively.

FIG. 12 shows the features selected as normalizing features for the exemplary data sets C₁ and C₂, initially shown in FIGS. 9A-B, with a rank-consistency threshold, based on the rankings shown in FIGS. 11A-B, of 5/60.

FIG. 13 shows the features selected as normalizing features for the exemplary data sets C₁ and C₂, initially shown in FIGS. 9A-B, with a rank-consistency threshold, based on the rankings shown in FIGS. 11A-B, of 3/60.

FIG. 14 shows the features selected as normalizing features for the exemplary data sets C₁ and C₂, initially shown in FIGS. 9A-B, with a rank-consistency threshold, based on the rankings shown in FIGS. 11A-B, of 1/60.

FIG. 15 shows the plot of data points shown in FIG. 10 with the normalizing features in the normalizing feature set shown in FIG. 14 indicated by a “ [symbol] ” symbol.

FIG. 16 shows one model for an expected distribution of observed log ratios for a particular feature.

FIG. 17 illustrates a range of 4 a symmetrically disposed with respect to the expected log ratio of zero, providing a p-value of 0.0456 assuming a normal distribution.

FIG. 18 illustrates separate normalization of feature subsets selected based on feature signal intensities.

FIG. 19 is a flow-control diagram for a routine “auto-refining normalization” that represents one embodiment of the present invention.

FIG. 20 is a flow-control diagram of the routine “evaluate,” called in step 1906 of FIG. 19.

FIG. 21 is a flow diagram for a first embodiment of the routine “determine intensity ranges,” called in step 1910 of FIG. 19.

FIG. 22 provides an alternate embodiment of the routine “determine intensity ranges.”

FIG. 23 is a flow-control diagram of the routine “refine sets of feature invariants,” called in step 1912 of FIG. 19.

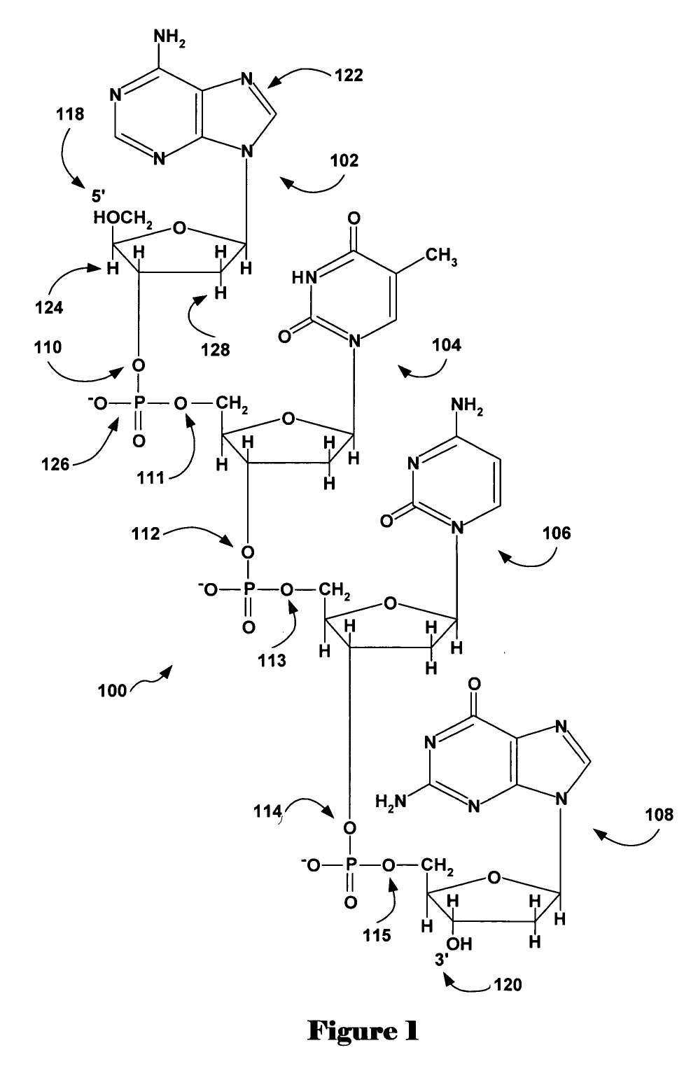

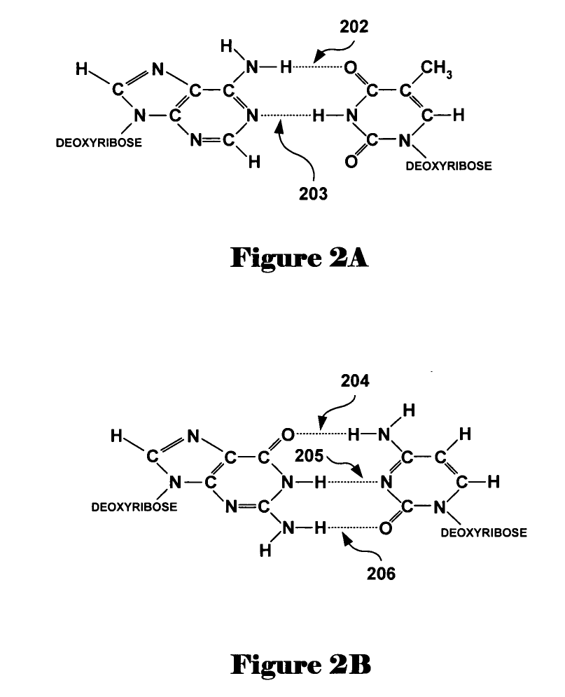

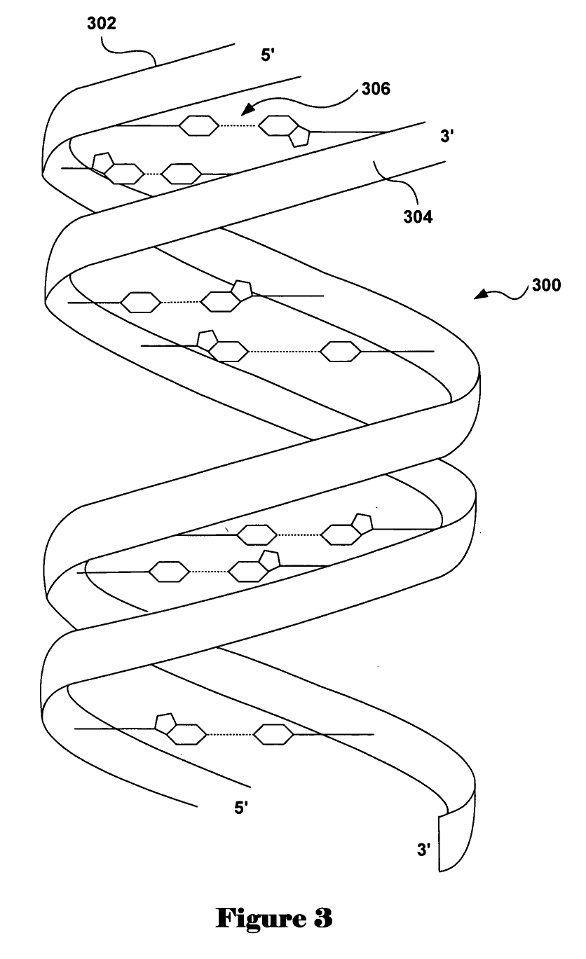

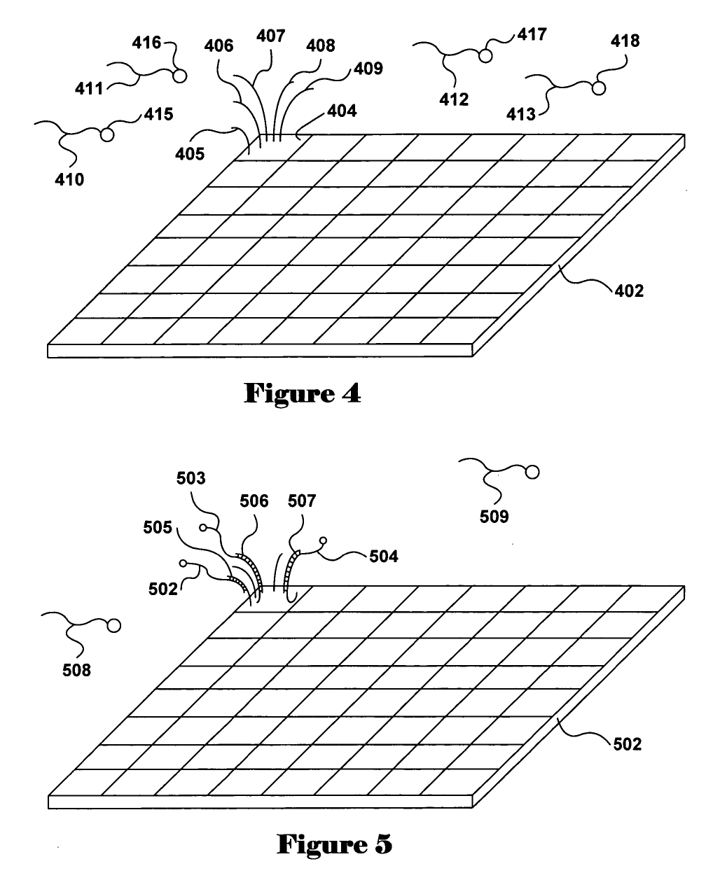

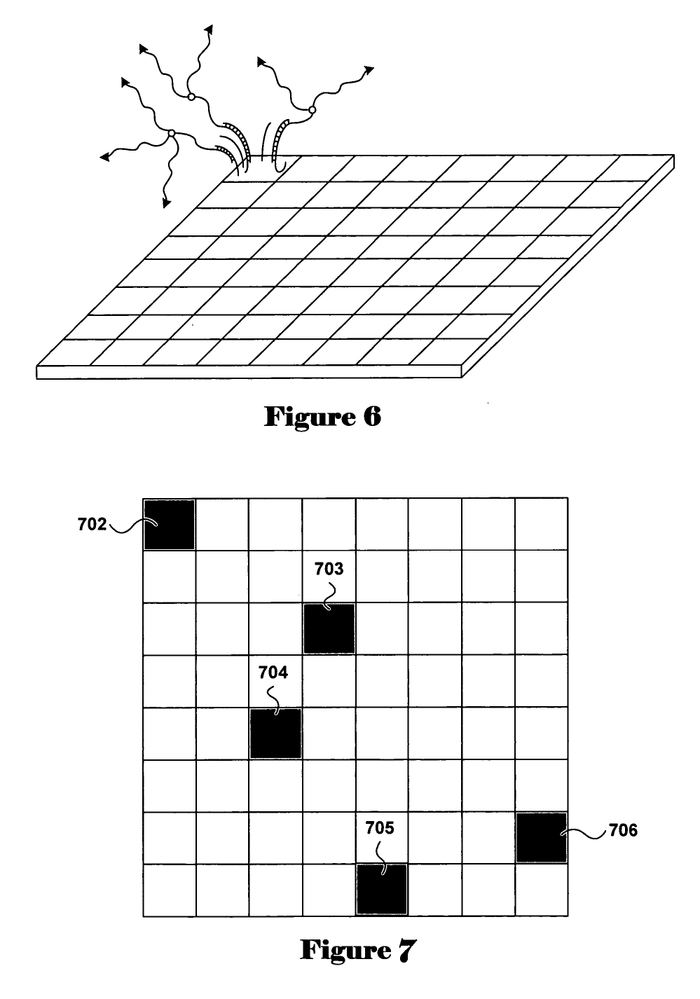

### DETAILED DESCRIPTION OF THE INVENTION

The present invention relates to a method for normalization of two or more data sets derived from microarray experiments, including a technique for ascertaining the quality of sets of features chosen as invariant, or normalizing, features during the normalization process. This technique can be used during an iterative approach to normalization in which a set of invariant, or normalizing, features is refined during each iteration. The technique for evaluating sets of normalizing features is described, below, following a description of the normalization process, followed by a flow-control-diagram description of one embodiment of an iterative normalization method. The present invention is discussed, below, in a second subsection following a first subsection that provides additional information about microarrays.

### Additional Information About Molecular Arrays

An array may include any one-, two- or three-dimensional arrangement of addressable regions, or features, each bearing a particular chemical moiety or moieties, such as biopolymers, associated with that region. Any given array substrate may carry one, two, or four or more arrays disposed on a front surface of the substrate. Depending upon the use, any or all of the arrays may be the same or different from one another and each may contain multiple spots or features. A typical array may contain more than ten, more than one hundred, more than one thousand, more ten thousand features, or even more than one hundred thousand features, in an area of less than 20 cm² or even less than 10 cm². For example, square features may have widths, or round feature may have diameters, in the range from a 10 μm to 1.0 cm. In other embodiments each feature may have a width or diameter in the range of 1.0 μm to 1.0 mm, usually 5.0 μm to 500 μm, and more usually 10 μm to 200 μm. Features other than round or square may have area ranges equivalent to that of circular features with the foregoing diameter ranges. At least some, or all, of the features may be of different compositions (for example, when any repeats of each feature composition are excluded the remaining features may account for at least 5%, 10%, or 20% of the total number of features). Interfeature areas are typically, but not necessarily, present. Interfeature areas generally do not carry probe molecules. Such interfeature areas typically are present where the arrays are formed by processes involving drop deposition of reagents, but may not be present when, for example, photolithographic array fabrication processes are used. When present, interfeature areas can be of various sizes and configurations.

Each array may cover an area of less than 100 cm², or even less than 50 cm², 10 cm or 1 cm². In many embodiments, the substrate carrying the one or more arrays will be shaped generally as a rectangular solid having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. Other shapes are possible, as well. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, a substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulsejets of either polynucleotide precursor units (such as monomers) in the case of in situ fabrication, or the previously obtained polynucleotide. Such methods are described in detail in, for example, U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein. Also, instead of drop deposition methods, known photolithographic array fabrication methods may be used. Interfeature areas need not be present particularly when the arrays are made by photolithographic methods as described in those patents.

A molecular array is typically exposed to a sample including labeled target molecules, or, as mentioned above, to a sample including unlabeled target molecules followed by exposure to labeled molecules that bind to unlabeled target molecules bound to the array, and the array is then read. Reading of the array may be accomplished by illuminating the array and reading the location and intensity of resulting fluorescence at multiple regions on each feature of the array. For example, a scanner may be used for this purpose, which is similar to the AGILENT MICROARRAY SCANNER manufactured by Agilent Technologies, Palo Alto, Calif. Other suitable apparatus and methods are described in U.S. patent applications: Ser. No. 10/087,447 “Reading Dry Chemical Arrays Through The Substrate” by Corson et al., and Ser. No. 09/846,125 “Reading Multi-Featured Arrays” by Dorsel et al. However, arrays may be read by any other method or apparatus than the foregoing, with other reading methods including other optical techniques, such as detecting chemiluminescent or electroluminescent labels, or electrical techniques, for where each feature is provided with an electrode to detect hybridization at that feature in a manner disclosed in U.S. Pat. No. 6,251,685, U.S. Pat. No. 6,221,583 and elsewhere.

A result obtained from a method disclosed herein may be used in that form or may be further processed to generate a result such as that obtained by forming conclusions based on the pattern read from the array, such as whether or not a particular target sequence may have been present in the sample, or whether or not a pattern indicates a particular condition of an organism from which the sample came. A result of the reading, whether further processed or not, may be forwarded, such as by communication, to a remote location if desired, and received there for further use, such as for further processing. When one item is indicated as being remote from another, this is referenced that the two items are at least in different buildings, and may be at least one mile, ten miles, or at least one hundred miles apart. Communicating information references transmitting the data representing that information as electrical signals over a suitable communication channel, for example, over a private or public network. Forwarding an item refers to any means of getting the item from one location to the next, whether by physically transporting that item or, in the case of data, physically transporting a medium carrying the data or communicating the data.

As pointed out above, array-based assays can involve other types of biopolymers, synthetic polymers, and other types of chemical entities. A biopolymer is a polymer of one or more types of repeating units. Biopolymers are typically found in biological systems and particularly include polysaccharides, peptides, and polynucleotides, as well as their analogs such as those compounds composed of, or containing, amino acid analogs or non-amino-acid groups, or nucleotide analogs or non-nucleotide groups. This includes polynucleotides in which the conventional backbone has been replaced with a non-naturally occurring or synthetic backbone, and nucleic acids, or synthetic or naturally occurring nucleic-acid analogs, in which one or more of the conventional bases has been replaced with a natural or synthetic group capable of participating in Watson-Crick-type hydrogen bonding interactions. Polynucleotides include single or multiple-stranded configurations, where one or more of the strands may or may not be completely aligned with another. For example, a biopolymer includes DNA, RNA, oligonucleotides, and PNA and other polynucleotides as described in U.S. Pat. No. 5,948,902 and references cited therein, regardless of the source. An oligonucleotide is a nucleotide multimer of about 10 to 100 nucleotides in length, while a polynucleotide includes a nucleotide multimer having any number of nucleotides.

As an example of a non-nucleic-acid-based molecular array, protein antibodies may be attached to features of the array that would bind to soluble labeled antigens in a sample solution. Many other types of chemical assays may be facilitated by array technologies. For example, polysaccharides, glycoproteins, synthetic copolymers, including block copolymers, biopolymer-like polymers with synthetic or derivitized monomers or monomer linkages, and many other types of chemical or biochemical entities may serve as probe and target molecules for array-based analysis. A fundamental principle upon which arrays are based is that of specific recognition, by probe molecules affixed to the array, of target molecules, whether by sequence-mediated binding affinities, binding affinities based on conformational or topological properties of probe and target molecules, or binding affinities based on spatial distribution of electrical charge on the surfaces of target and probe molecules.

Scanning of a molecular array by an optical scanning device or radiometric scanning device generally produces a scanned image comprising a rectilinear grid of pixels, with each pixel having a corresponding signal intensity. These signal intensities are processed by an array-data-processing program that analyzes data scanned from an array to produce experimental or diagnostic results which are stored in a computer-readable medium, transferred to an intercommunicating entity via electronic signals, printed in a human-readable format, or otherwise made available for further use. Molecular array experiments can indicate precise gene-expression responses of organisms to drugs, other chemical and biological substances, environmental factors, and other effects. Molecular array experiments can also be used to diagnose disease, for gene sequencing, and for analytical chemistry. Processing of molecular-array data can produce detailed chemical and biological analyses, disease diagnoses, and other information that can be stored in a computer-readable medium, transferred to an intercommunicating entity via electronic signals, printed in a human-readable format, or otherwise made available for further use.

### The Present Invention

When a microarray is scanned, a pixel-based image of each feature, and the surface of the microarray surrounding each feature, is produced. One or more sets of digital signal-intensity data, with the intensity of a particular signal measured at each pixel, may be produced from a microarray. In general, two or more data sets may be produced from a single microarray, and an experiment may involve a series of microarrays, each providing two or more data sets. Microarray experiments may commonly involve two or more data sets, which all need to be normalized in order for comparisons of the feature signals between data sets to be made. For example, microarrays are routinely used for measuring differential gene expression. A microarray may be first exposed to a first sample of mRNA isolates obtained from a tissue in a first, control state, the mRNA isolates labeled with a first chromophore that produces a first signal C₁, and later exposed to a second sample solution containing mRNA isolates from the tissue in a pathological or otherwise perturbed state, the mRNA isolates in the second sample solution labeled with a second chromophore that produces a second signal C₂. Each feature includes an oligonucleotide probe designed to bind to a particular mRNA target. Thus, comparing the C₁ and C₂ signals scanned from a particular feature provides an indication of the relative levels of expression of the target mRNA in the control and perturbed state. However, to make a valid comparison of the expression levels, the C₁ data set must be normalized with respect to the C₂ data set. For example, the C₂ chromophore may less efficiently fluoresce than the C₁ chromophore, so that the C₂ data set is shifted, in intensity, with respect to the C₁ data set. Prior to normalization of the data sets, no inference can be made about the relative expression levels of the target mRNAs based on the measured signals.

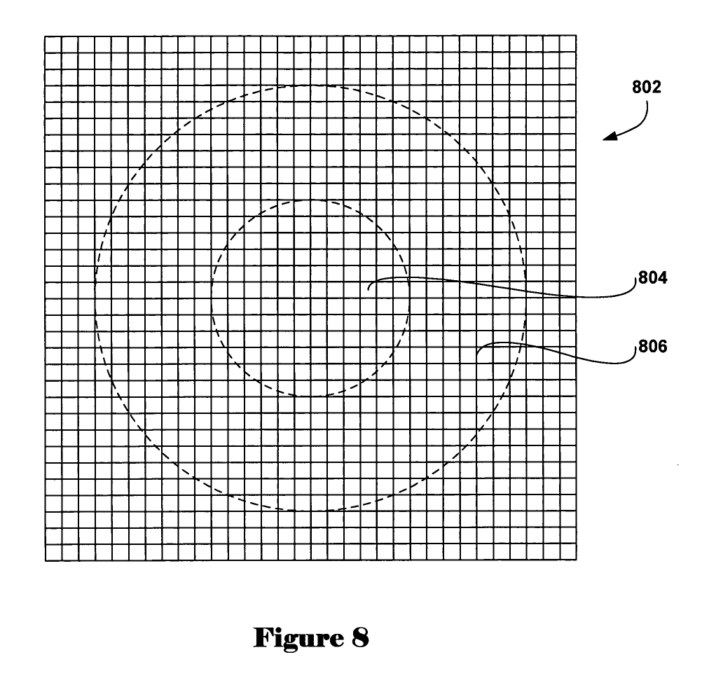

FIG. 8 illustrates a square region of the surface of a microarray that includes a single feature. In FIG. 8, the feature 804 is a disk-shaped region at the center of the square sub-region 802 of the microarray surface. The raw intensity for the feature is obtained by integrating the individual pixel intensities over the disk-shaped region of the feature 804. Identification of the proper location, size, and shape of a feature is the subject of previously filed applications, including U.S. application Ser. No. 10/589,046. The raw, integrated intensity at a particular optical wavelength corresponds to a raw signal for the feature. When the microarray is scanned at the florescent wavelength for a first chromophore C₁, the integrated intensity for the feature corresponds to the raw signal C₁ for the feature. An initial adjustment to the raw signal intensity concerns subtraction of a background intensity from the raw signal intensity. There are many ways to determine the appropriate background signal to subtract from the raw intensity to obtain the background-adjusted signal. In one approach, the pixel intensities within an annular region 806 surrounding the feature are integrated and averaged to produce an average background per surface area which can then be multiplied by the area of the feature and subtracted from the integrated signal intensity of a feature to produce a background-adjusted signal for the feature. In addition to producing the background-adjusted signal, the background region and feature region can be statistically analyzed to produce a variance σ² for the feature.

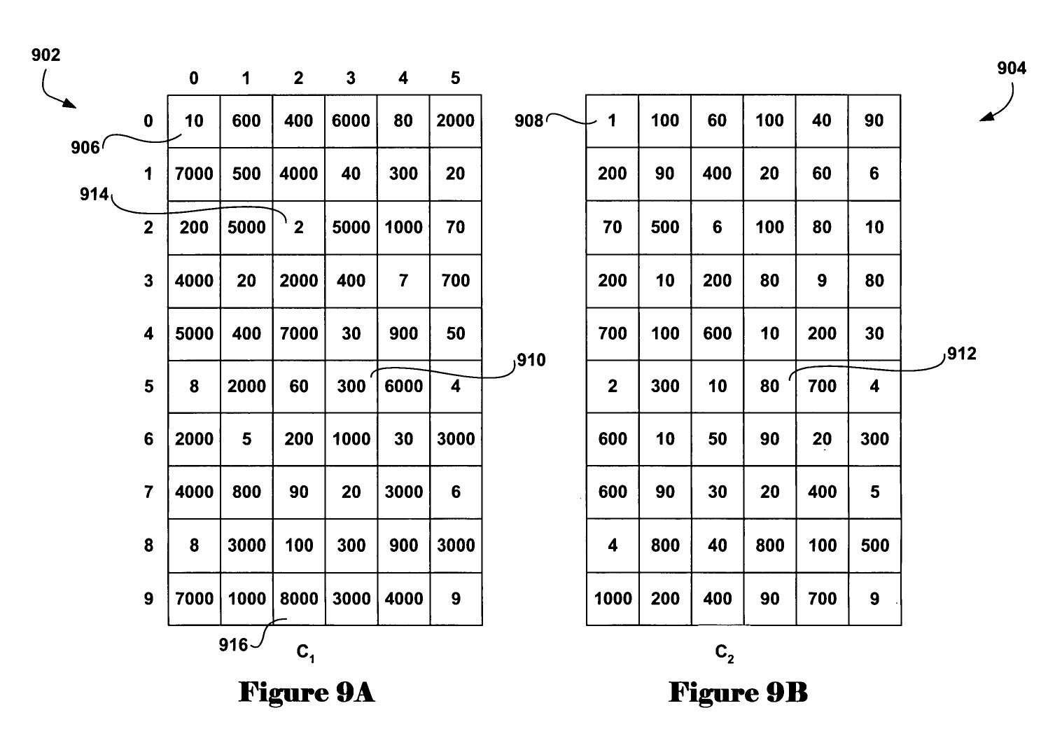

FIGS. 9A-B illustrate two, very small, exemplary data sets produced from a hypothetical two-signal microarray experiment. In FIG. 9A, a two-dimensional matrix 902 of background-adjusted C₁ signals for sixty features is provided. In FIG. 9B, a similar two-dimensional matrix 904 for the C₂ background-adjusted signals for the same sixty features is shown. The features may be identified using a pair of indices in the standard manner of indicating elements within a two-dimensional matrix. For example, feature (0,0) has the C₁ background-adjusted signal “10” 906 and has the C₂ background-adjusted signal “1” 908. In the following, the signals are assumed to background-adjusted, and thus the term “background-adjusted” will be omitted. Similarly, the feature (3,5) has C₁ signal intensity of “300” 910 and the C₂ signal intensity “80” 912. Note that the C₁ and C₂ data sets, shown in matrices 902 and 904, respectively, are not normalized. Therefore, assuming that the microarray contains oligonucleotide probes directed to target mRNAs, it is not possible, prior to normalization, to make any judgment about the relative levels of expression of the mRNAs in the tissue samples corresponding to the C₁ and C₂ data sets.

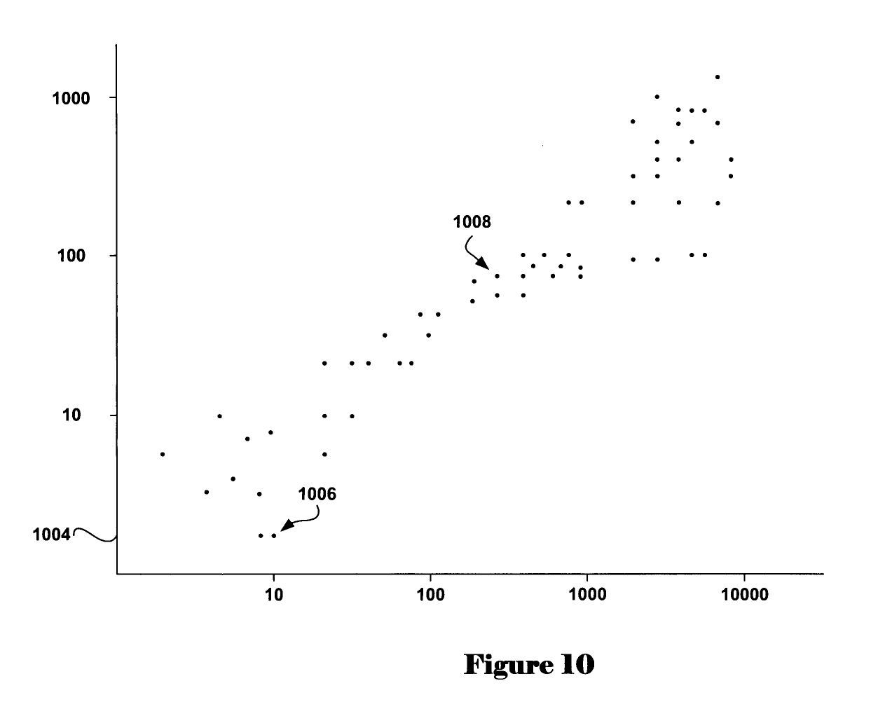

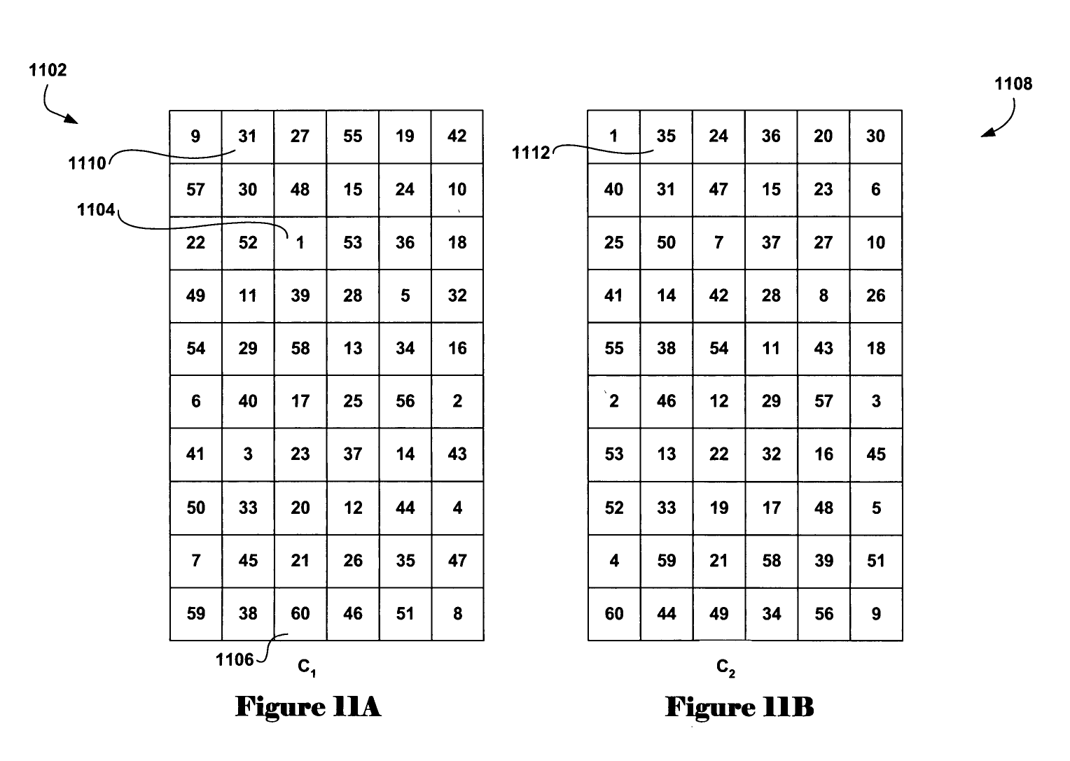

FIG. 10 shows a two-dimensional plot of the combined C₁ and C₂ data sets shown in FIGS. 9A-B. In FIG. 10, the horizontal axis 1002 is logarithmically scaled and corresponds to the C₁ intensity of the plotted features, and the vertical axis 1004 is also logarithmically scaled and corresponds to the C₂ intensity of the plotted features. Thus, for example, feature (0,0) corresponds to plotted data point 1006 in the two-dimensional plot, while feature (3,5) corresponds to the plotted data point 1008 in the two-dimensional plot. The plot shown in FIG. 10 exhibits characteristics often observed in microarray data sets. In the middle portion of the plot, near data point 1008, the data points tend to be relatively closely clustered together. However, in the extreme portions of the distribution, such as the lower extreme portion inhabited by data point 1006, the data points tend to have greater variance, and are often more diffusely distributed.

A common approach to normalizing multiple data sets is to attempt to identify invariant, or normalizing, features corresponding to target molecules having equivalent concentration in the sample solutions to which the microarray is exposed in order to generate the multiple data sets. Thus, for example, assuming that the features contain oligonucleotide probes directed to target mRNAs, an effective set of invariant, or normalizing features, would be features containing oligonucleotide probes directed to mRNAs that are not differentially expressed over the course of the microarray-based experiments. If a normalizing constant or an intensity-dependent normalization function can be obtained from the normalizing, features, then the C₁ data set can be normalized to the C₂ data set using the normalization constant, or intensity-dependent normalization function.

FIGS. 11A-15 illustrate a rank-consistency approach to determining an intensity-dependent normalization function. FIGS. 11A-B show a sequential ranking of the features in the C₁ and C₂ data sets, respectively. In FIG. 11A, the elements of the displayed matrix 1102 include the rank order of the features within the C₁ data set, where the order is determined with respect to the magnitudes of the C₁ signal intensities for the features. For example, feature (2,2) has the lowest C₁ signal intensity of “2” (914 in FIG. 9a), and therefore is assigned the rank order “1” 1104. Figure (2,9) has the highest C₁ signal intensity of “8000” (916 in FIG. 9A), and therefore has the highest rank order of “60” 1106. The features are ranked with respect to C₂ signals in the two-dimensional matrix 1108 shown in FIG. 11 B.

Following the ranking of the features by intensity in each data set, a normalizing feature set is obtained by comparing the respective rankings for each feature and selecting, for the normalizing feature set, those features that have relatively similar rankings in all data sets. For a two-data-set problem, the rank consistency of a feature i, RCᵢ is given by the following expression:

$$R {C}_{i} = \frac{\vert {ρ}_{i , {C}_{1}} - {ρ}_{i , {C}_{2}} \vert}{N}$$

where ρ_{i,C}_{₁} and ρ_{i,C}_{₂} are the ranks of feature i in the C₁ and C₂ sets, respectively; and
and N is the number of features
For more than two data sets, various different rank consistency metrics may be used, including, for example:

$$R {C}_{i} = \frac{{\sum }_{j = 1}^{n} {\sum }_{k = 1}^{n} \vert {ρ}_{i , {C}_{j}} - {ρ}_{i , {C}_{k}} \vert}{( {n}^{2} - n ) N}$$

where n is the number of data sets
In all cases, one selects features for the normalizing feature set relatively constant in rank among the two or more data sets by requiring that the rank-consistency metric for a normalizing feature be less than some threshold value τ:
RCᵢ≦τ

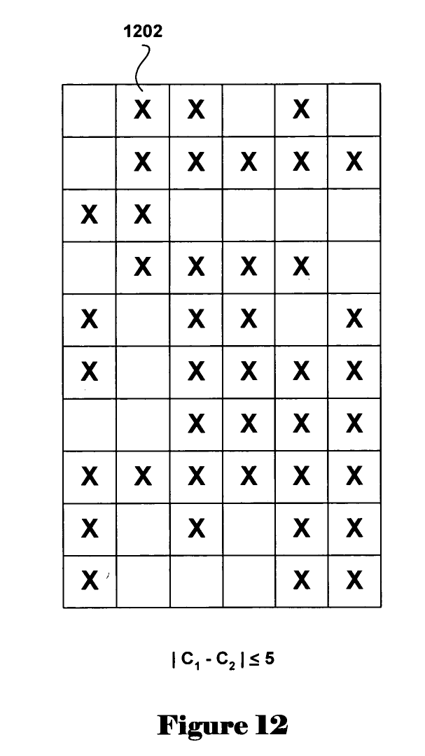

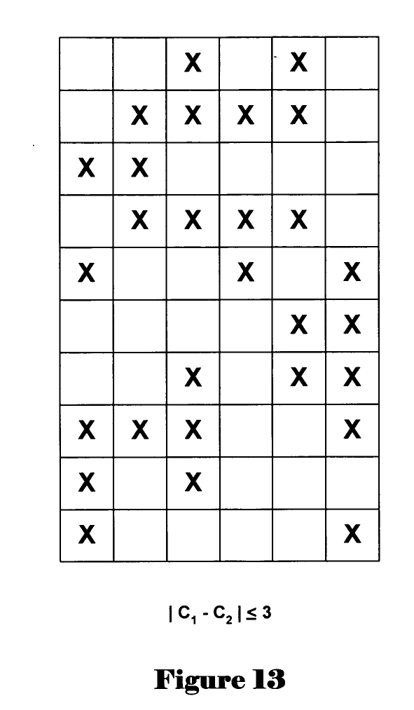

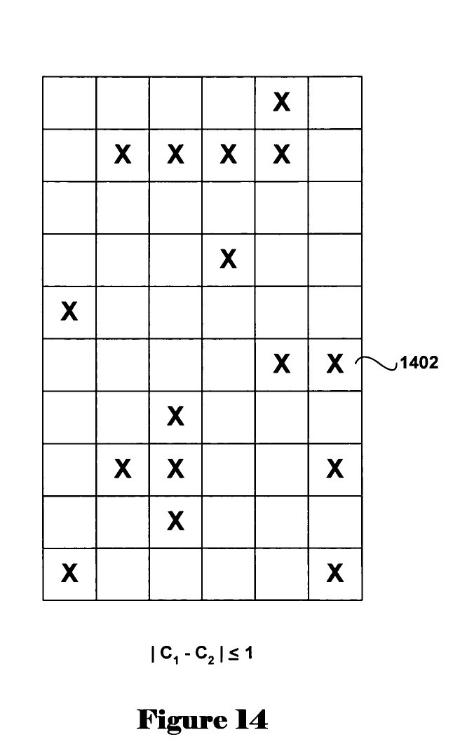

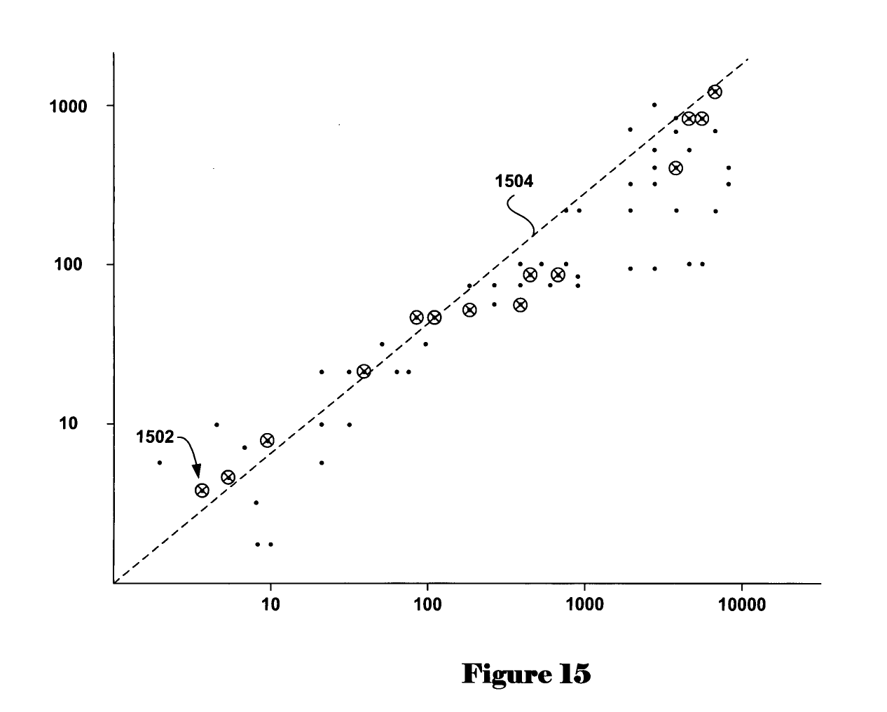

The choice of τ controls the number of features in the normalizing feature set. For example, FIG. 12 shows the features selected as normalizing features for the exemplary data sets C₁ and C₂, initially shown in FIGS. 9A-B, when the selection criteria is that the rank-consistency metric, based on the rankings shown in FIGS. 11A-B, is less than or equal to a τ of 5/60. The normalizing features are indicated, in FIG. 12, with an “x” symbol. For example, feature (1,0) has rank “31” 1110 in FIG. 11A in the C₁ data set, and rank 35 (1112 in FIG. 11B) in the C₂ data set. The rank-consistency metric is thus 4/60, which is less than or equal to the τ of 5/60. Therefore, feature (1,0) 1202 is selected as a normalizing feature. Decreasing τ to 3/60 produces the smaller normalizing feature set shown in FIG. 13, and decreasing τ to 1/60 produces the normalizing feature set shown in FIG. 14. FIG. 15 shows the plot of data points shown in FIG. 10 with the normalizing features in the normalizing feature set shown in FIG. 14 indicated by a “ [symbol] ” symbol. For example, feature (5,5) 1402 is shown in the data plot of FIG. 15 with a “ [symbol] ” symbol 1502. As can be seen in FIG. 15, the selected normalizing features tend to fall within the central tendency of the data-point distribution.

The normalizing features can then be used, through linear regression or some other, more complex non-linear curve-fitting technique, to define the central tendency within the data distribution. In FIG. 15, the central tendency is defined as a straight line, shown as a dashed line 1504 in FIG. 15, on the log/log plot. This allows for development of a normalization function to relate the C₁ and C₂ data sets. The fact that the normalization function is a straight line in log/log space means that, for normalizing features, the C₁ values should be related to the C₂ values by the following expressions:

$$\begin{matrix}log {C}_{2} = x log {C}_{1} \\ log {C}_{2} = log {C}_{1}^{x} \\ {C}_{2} = {C}_{1}^{x} \\ {C}_{1} = {C}_{2}^{\frac{1}{x}}\end{matrix}$$

For example, consider feature (4,0) with C₁ signal intensity equal to “80” and C₂ equal to “40.” If the C₁ signal is normalized to the C₂ signal, then the C₁ normalized signal is:

$$\begin{matrix}{C}_{1} = {C}_{2}^{1.266} \\ = {40}^{1.266} \\ = 106.7\end{matrix}$$

where x is determined from the slope of the line in FIG. 15 to be 0.7899
However, if C₂ is normalized to C₁, then the normalized value for C₂ is given by:

$$\begin{matrix}{C}_{1} = {C}_{2}^{0.7899} \\ = {80}^{0.7899} \\ = 18.42\end{matrix}$$

Therefore, using normalized data, the observed log ratio for the feature in the two data sets,

$$log ( \frac{{C}_{1}}{{C}_{2}} ) ,$$

may be either 0.426 or 0.637, depending on whether C₁ is normalized to C₂ or C₂ is normalized to C₁. Compromising, and taking the average of the two values, then the estimated, observed normalized log ratio is 0.531 for feature (4,0).

In evaluating a normalizing feature, the estimated, observed normalized log ratio may be compared to the expected normalized log ratio of 0 in order to judge whether the feature is or is not differentially expressed in the two data sets. Clearly, if the feature is differentially expressed, it is not a good candidate for inclusion in the normalizing feature set. To answer the question, one must have a reasonable estimate of the variances σ_{c}_{₁}² and σ_{c}_{₂}² for the observed feature signal intensities in the two data sets. Estimate of these variances can be derived from the variances determined from pixel intensity statistics, as discussed in U.S. application Ser. No. 09/589,046. These variances can then be used to calculate a variance for the observed log ratio for the feature.

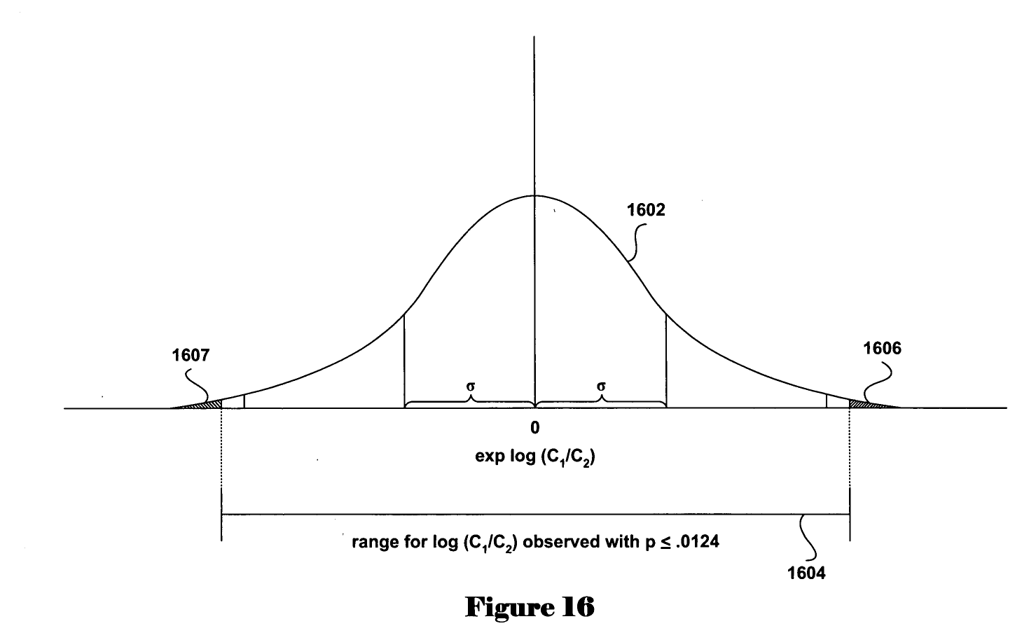

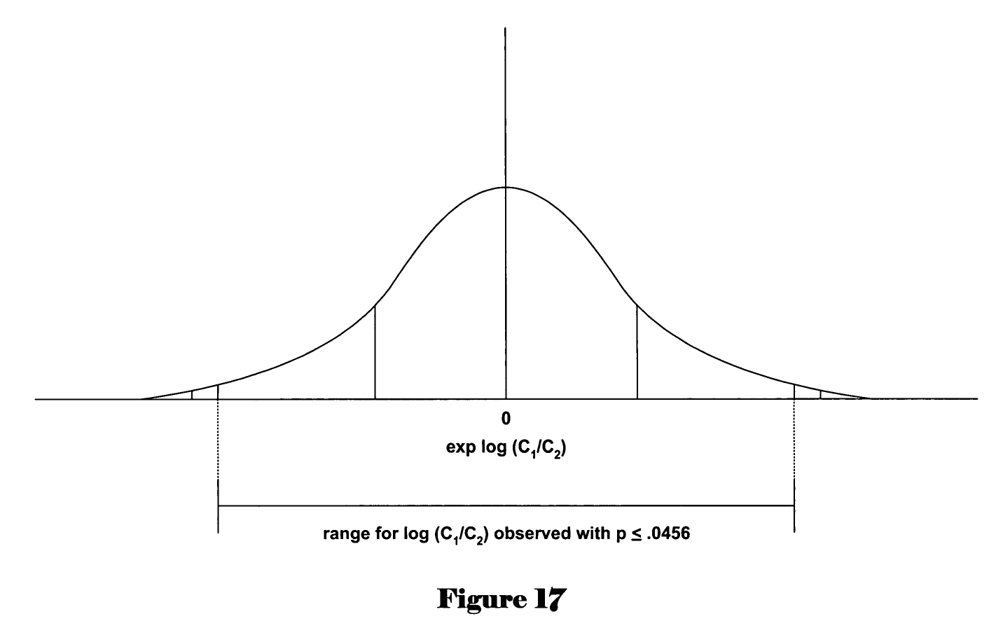

FIG. 16 shows one model for an expected distribution of observed log ratios for a particular feature. In this model, the observed log ratios are expected to fall within a normal distribution 1602. The expected log ratio for a normalizing feature is 0. Accordingly to the normal distribution, 68% of observed log ratios, when the standard deviation for observed log ratios is σ, should fall within one standard deviation on either side of the expected value of 0. Another way to look at this is that when an observed log ratio falls within some reasonable distance, in units of standard deviations, from the expected value, it can be assumed to be within a statistically reasonable range of observed log ratio values expected for a true log ratio of 0. Thus, for example, if the observed log ratio falls outside of the range indicated by the horizontal line segment 1604 in the FIG. 16, the probability that the true log ratio is actually zero corresponds to the sum of the two shaded areas 1606 and 1607 beneath the normal distribution curve 1602 outside of the range. The p-value is equal to this probability of mischaracterizing an observed log ratio that falls outside of a specified range as not being the result of a true log ratio of zero, and therefore representing differential expression of a feature in the two data sets. The p-value is a measure of the significance level for an inference based on an observed value. In FIG. 16, the range 1604 corresponds to five σ, and the probability of mischaracterizing a feature as differentially expressed when the observed log ratio for the feature falls outside of this range is 0.0124. FIG. 17 illustrates a range of 4 a symmetrically dispersed with respect to the expected log ratio of zero, providing a p-value of 0.0456. Therefore, the observed log ratio for feature (4,0) estimated as 0.532 falls within the range, shown in FIG. 17, corresponding to a p-value of 0.0456 when the standard deviation for the log ratio is 0.266. However, if the standard deviation for the log ratio is below 0.266, then the observed log ratio would outside the range at p-value 0.0456 and would therefore be assumed to indicate differential expression at that p-value. The narrower the change chosen, the higher the p-value.

This observation motivates a metric, Φ, to evaluate the quality of a normalizing feature set, where Φ is given as follows for normalization of two data sets:

$${Φ}_{p} = \frac{{\sum }_{i = 1}^{M} {δ}_{i}}{M}$$

where

$${δ}_{i} = 1 when log ( \frac{{C}_{i , 1}}{{C}_{i , 2}} )$$

is outside the specified range for p-value=p, and

$${δ}_{i} = 0 when log ( \frac{{C}_{i , 1}}{{C}_{i , 2}} )$$

is inside the specified range for p-value=p
In other words, the metric Φp is the percentage of features in the normalizing feature set that are differentially expressed when a statistical range is chosen for each feature to provide a p-value of p. The metric Φp can be extended to more than two dimensions:

$${Φ}_{p} = \frac{{\sum }_{i = 1}^{M} {δ}_{i , j , k}}{{n}^{2} M}$$

where

$${δ}_{i , j , k} = 1 when log ( \frac{{C}_{i , j}}{{C}_{i , k}} )$$

is outside the specified range for p-value=p for any j and k, and

$${δ}_{i , j , k} = 0 when log ( \frac{{C}_{i , j}}{{C}_{i , k}} )$$

is inside the specified range for p-value=p for all j and k
This multiple-set Φₚ can be relaxed by requiring only that some threshold percentage of log ratios calculated for a feature fall within the specified range.

The ability to alter the size of the normalizing feature set by changing the value of τ, the rank-consistency threshold, as described above, and the ability to quantify the quality of a normalizing feature set using the metric Φₚ, together motivate an iterative approach to constructing a normalizing feature set. An initial normalizing feature set can be obtained using a default value for τ and a default p-value, with a default threshold value for the metric Φₚ, Φₜₕᵣₑₛ, used to determine whether the initial normalizing feature set is acceptable. If the metric Φₚ calculated for the initial normalizing feature set is below the Φ threshold, Φₜₕᵣₑₛ, then a reasonable normalizing feature set has been obtained. However, if the initial normalizing feature set produces a Φₚ metric value greater than Φₜₕᵣₑₛ, then τ can be decreased in order to select a more constrained, smaller normalizing feature set. This process can continue until either the Φ metric falls below Φₜₕᵣₑₛ or a minimum number of normalizing features is obtained with the current value of τ. In contrast to the iterative process, it is also possible to apply τ as a function of intensity, where the stringency of τ increases with increasing intensity. This is because, at higher intensity, due to the general sparseness of probes, there is a higher probability of probes being mistakenly labeled rank consistent.

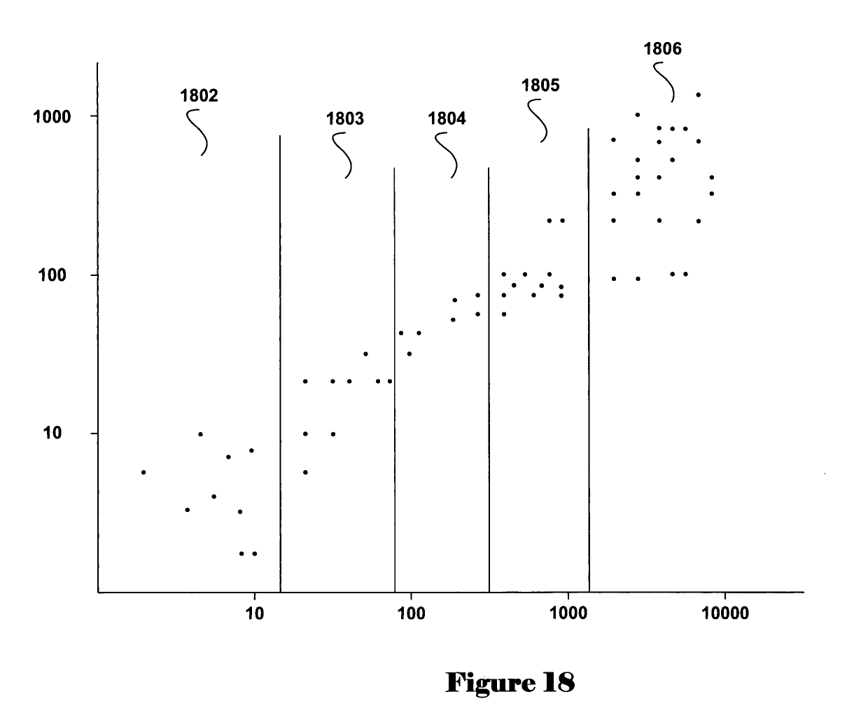

FIG. 18 illustrates separate normalization of feature subsets selected based on feature signal intensities. In FIG. 18, the exemplary C₁ and C₂ data sets are plotted, as in FIG. 10. However, the range of C₁ feature signal intensities has been divided into five regions 1802-1806. The iterative normalization process may be applied separately to each of the feature-intensity regions 1802-1806, using different default values of τ and possibly different default p-values. The intent is to apply more severe constraints in the extreme-intensity regions 1802 and 1806 in order to more discriminatingly select normalizing features from those regions. A less discriminating T may be used for regions 1803 and 1805, and either a very high value for τ may be used for region 1804, or, in many cases, no additional iterative steps may be needed for the central intensity region, since data points tend to be fairly closely distributed about the central tendency, with low variance, in the central-intensity region. Many different possible approaches can be used to carry out the iterative normalizing-feature-set-selection process, and many different approaches may be taken to divide features into feature subsets based on ranges of signal intensities in one or more data sets. In FIG. 18, for example, the size of the ranges are not equal, but instead reflect a range of variances within signal-intensity subregions the plotted data points. In alternative embodiments, fixed feature-signal-intensity ranges may be used to partition the features. In still other embodiments, the number of feature-signal-intensity ranges may be variable, with regions split only as needed to obtain reasonably sized normalizing feature sets distributed reasonably evenly throughout the distribution of data points.

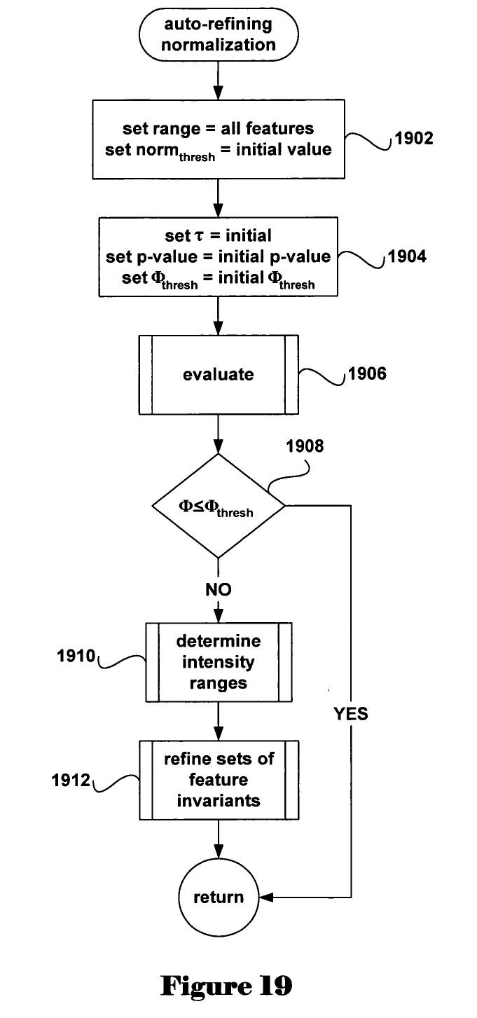

A flow-control-diagram description of one embodiment of an iterative normalizing-feature-set selection process is next provided, with reference to FIGS. 19-23. This described embodiment is but one of an almost limitless number of possible approaches to iteratively selecting a normalizing feature set for normalization of two or more microarray data sets that uses the concepts of adjusting the rank-consistency threshold τ, evaluating the quality of normalizing feature sets using the metric Φ, and that may also employ a partition of the features into subsets with respect to feature intensity.

FIG. 19 is a flow-control diagram for a routine “auto-refining normalization” that represents one embodiment of the present invention. This routine assumes that it is being furnished two or more background-corrected microarray data sets. In step 1902, the routine “auto-refining normalization” sets an initial feature-signal-intensity range to include all features common to the two or more data sets, and sets the minimum number of normalizing features, normₜₕᵣₑₛ, to an initial value, generally a specific percentage of the total number of features common to the two or more data sets. In step 1904, the routine “auto-refining normalization” sets τ to an initial default value, sets p-value to an initial, default p-value, and sets Φₜₕᵣₑₛ to an initial Φ-metric threshold value. In alternative embodiments, rather than being specified within an implementing program as default values, the initial values for one or more of τ, the p-value, and Φₜₕᵣₑₛ may be specified by an interactive user of a data processing program, may be specified in a computer-readable data file, or may be otherwise specified. In step 1906, the routine “auto-refining normalization” calls the routine “evaluate” to initially normalize the two or more data sets, and to calculate an initial value for the Φ-metric. In step 1908, the routine “auto-refining normalization” determines whether the calculated value for metric Φ is less than or equal to Φₜₕᵣₑₛ. If so, then the initial normalizing feature set, selected by the routine “evaluate,” is adequate, and the routine returns. Otherwise, the routine “auto-refining normalization,” in step 1910, calls the routine “determine intensity ranges” to divide the features into separate sets according to the feature signal intensities in one or more dimensions. Then, in step 1912, the routine “auto-refining normalization” calls the routine “refine sets of feature invariants” to determine, in iterative fashion, new sets of normalizing features for each of the subsets of features determined in step 1910 by adjusting r, and perhaps other parameters.

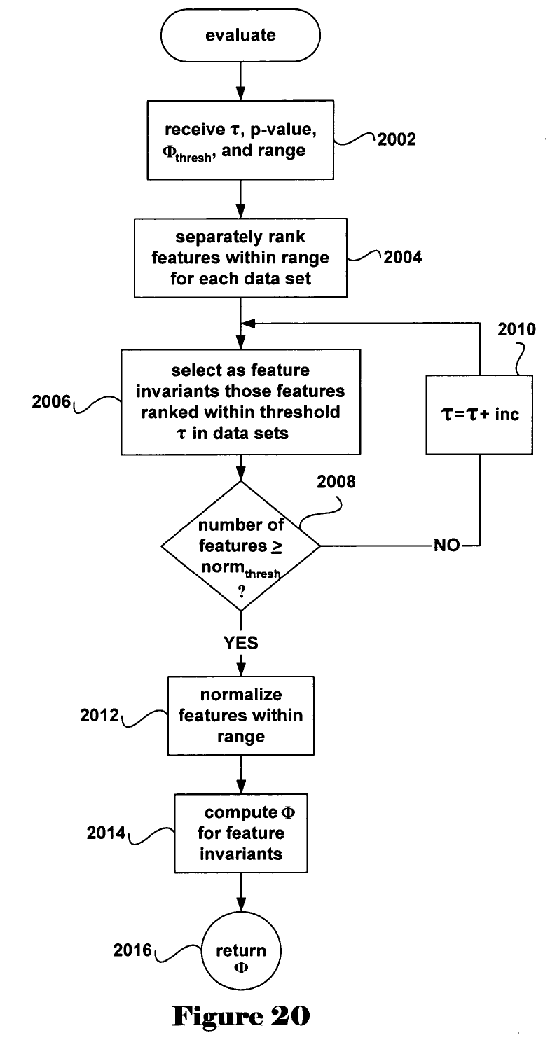

FIG. 20 is a flow-control diagram of the routine “evaluate,” called in step 1906 of FIG. 19. In step 2002, the routine “evaluate” receives initial values for τ, p-value, Φₜₕᵣₑₛ, and the range of feature signal intensities in one or more dimensions that defines the subset of features to be evaluated. In step 2004, the features are ranked according to feature-signal intensity in each data set within the specified range. In step 2006, the routine “evaluate” selects, as normalizing features, those features ranked within a rank consistency equal to or less than τ in the two or more data sets, according to the rank-consistency feature-selection method described above. In step 2008, the routine “evaluate” determines whether or not the number of features selected is greater than or equal to normₜₕᵣₑₛ. If not, then τ is incremented, in step 2010, and control returned to step 2006 to again select a set of normalizing features. Once a set of normalizing features is selected, the routine “evaluate,” in step 2012, normalizes the features within the specified range using the set of normalizing features. Then, in step 2014, the routine “evaluate” computes a value for the Φ metric for the set of normalizing features determined in the last iteration of step 2006. The value for the Φ metric is returned in step 2016.

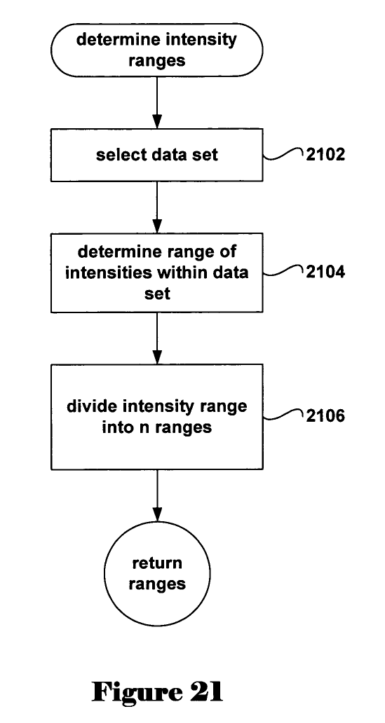

As indicated above, there are many different ways to determine the intensity ranges used to partition the features, as, for example, in FIG. 18. FIG. 21 is a flow diagram for a first embodiment of the routine “determine intensity ranges,” called in step 1910 of FIG. 19. In step 2102, a data set is selected for the basis of a division. Next, in step 2104, the range of intensities within the selected data set is determined. Finally, in step 2106, the determined intensity range is divided into n ranges representing partitioning of the features into n subsets, for each of which the normalizing feature set is iteratively determined by the routine “refine sets of feature invariance.”

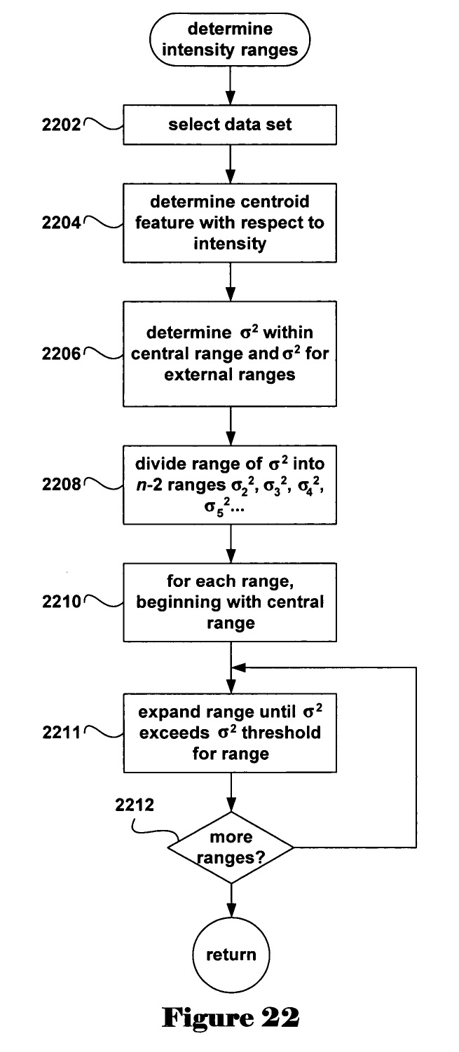

FIG. 22 provides an alternate embodiment of the routine “determine intensity ranges.” In step 2202, a data set is selected. In step 2204, the centroid feature within the data set with respect to intensity is determined. Next, in step 2206, the variance, σ², within a central portion of the data set is determined, along with the variance in extreme-intensity portions of the data set. Next, in step 2208, the range of variances occurring within the data set is divided into n−1 ranges σ₁, σ₂, σ₃, σ₄, . . . . Then, in the for-loop comprising steps 2210-2212, the central range is expanded in both directions until the variance, initially σ₁, rises to σ₂. At that point, the central range is fixed, and the next two features-signal-intensity ranges on either side of the central range are expanded until the variance within those regions equals or exceeds the variance σ₃ and σ₄, respectively. These next two ranges are then closed, and the subsequent ranges are expanded by adding data points until the variance within the subsequent ranges exceeds σ₅ and σ₆, respectively. This process continues until n−2 interior ranges are fixed, with the final two ranges open ended.

In yet additional alternative embodiments of the routine “determine intensity ranges,” more than one data set may be used for partitioning the features into subsets with regard to feature signal-intensity ranges. In addition, many other approaches to division are possible.

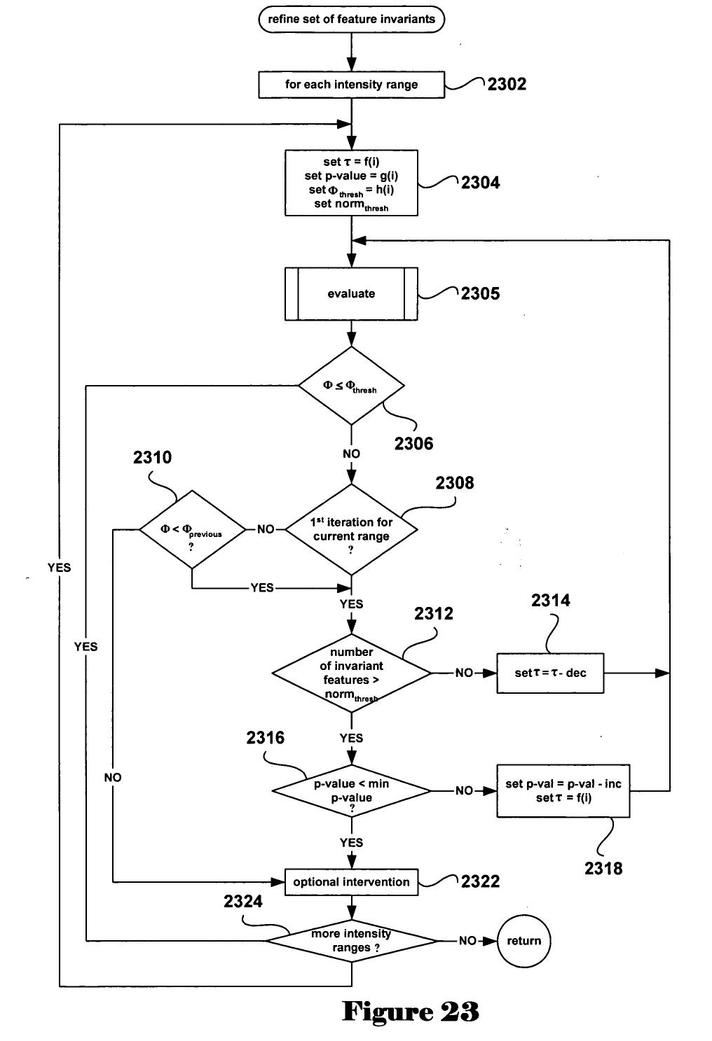

FIG. 23 is a flow-control diagram of the routine “refine set of feature variance.” This routine is essentially a largefor-loop, beginning with step 2302 and ending with step 2324 that refines the normalizing feature sets for each of the feature subsets determined by the routine “determine intensity ranges.” For each feature subset, initial values for τ, p-value, Φₜₕᵣₑₛ and normₜₕᵣₑₛ are determined, in step 2304. Note that these default values are intensity-range dependent, so that, for example, τ is set to smaller, more constraining values at extreme feature-signal intensities. Then, in step 2304, the routine “evaluate” is called to select a first set of normalizing features for the intensity range and to calculate the value of the metric Φ. If the calculated value of Φ is less than or equal to Φₜₕᵣₑₛ as determined in step 2306, then the first normalizing feature set is adequate, and control flows to step 2324, where the for-loop is again iterated if there is another feature subset to calculate a set of normalizing features for. Otherwise, in step 2308, the routine “refine set of feature invariance” determines whether or not the current iteration is the first iteration for a particular range. If not, in step 2310, the routine “refine set of feature invariance” determines whether or not the calculated value for Φ is less than the previously calculated value of Φ. If not, the control flows to step 2322, where optionally manual intervention may be suggested, or additionally steps may be taken, to determine whether or not the current normalizing feature set is optimal. However, if the value Φ has decreased, or the current iteration is the first iteration for the current feature subset, then, in step 2312, the routine “refine set of feature invariance” determines whether the number of normalizing features selected in step 2304 is greater than some maximum number of features generally calculated as a percent of the total number of features. If not, then, in step 2314, τ is documented and control flows back to step 2304 for selection of a new normalizing feature set. However, if τ cannot be further adjusted, as determined in step 2312, then, in step 2316, the routine “refine set of feature invariance” determines whether or not p-value is less than some minimum allowable p-value. If not, then in step 2318, p-value is decreased, τ is set back to the initial default value, and control flows back to step 2304 for a selection of a new normalizing feature step. Otherwise, if not further adjustments to τ or p-value can be made, then an optional intervention step 2322 allows for independent manual intervention or additional steps to determine whether the current normalizing feature set is, in fact, optimal. The final normalization may be a piece-wise normalization, using the different normalizing feature sets obtained by the iterative method, or the normalizing feature sets may be combined to produce a final, inclusive normalizing feature set that is used in a final normalization step to produce normalized data sets.

Although the present invention has been described in terms of a particular embodiment, it is not intended that the invention be limited to this embodiment. Modifications within the spirit of the invention will be apparent to those skilled in the art. For example, as discussed above, an almost limitless number of iterative approaches to selecting normalizing features sets may be devised and implemented that employ the basic methods of the present invention, including altering the rank-consistency threshold τ and testing each normalizing feature set using the metric Φₚ. As discussed above, the method of the present invention may be applied to any number of data sets greater than or equal to two. Additionally parameters may be varied in order to optimize feature sets, and additional techniques may be employed to further winnow normalizing feature sets. Variations on the rank-consistency metric RC and rank-consistency-threshold τ are possible. Different variations of the metric Φₚ are also possible. For example, these values may be multiplied by constants, computed over restricted ranges of features, use, in the case of Φₚ, continuous values rather than discrete values, etc. In the described implementation, an initial set of normalizing features is obtained by an initial application of the rank-consistency method to the received data sets, but in alternative embodiments, an initial set of normalizing features may be provided to the implementation, by, among other sources, a human user selecting normalizing features through a data-set viewing program, or from computer files containing normalizing-feature sets that have been used in similar experiments, or that have been identified as being good candidates over a period of time or over a series of experiments. Such initially provided sets of normalization features would then be successively refined using the Φₚ-based evaluation and iterative rank-consistency threshold τ tightening techniques described above.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for computing a quality metric for a set of normalizing features comprising features employed to normalize two or more microarray-derived data sets, the method comprising:
for each feature in the set of normalizing features,
determining whether the feature is differentially expressed among the two or more microarray-derived data sets;
determining a fraction of the features in the normalizing features that are differentially expressed; and
providing as the quality metric one or more of:
the determined fraction of the features in the normalizing features that are differentially expressed; and
a value based on the determined fraction of the features in the normalizing features that are differentially expressed.

2. The method of claim 1 wherein determining whether the feature is differentially expressed among the two or more microarray-derived data sets further includes:
determining an observed signal-based value for the feature for each pair of data sets,
determining whether each observed signal-based value falls within a range of observed signal-based expected for an invariant feature at a significance level equal to a particular p-value, and
determining from the number of observed signal-based values that fall outside the range of signal-based values expected for an invariant feature whether the feature is differentially expressed.

3. The method of claim 2 wherein determining from the number of observed signal-based values that fall outside the range of signal-based values expected for an invariant feature whether the feature is differentially expressed further includes:
determining whether a ratio of the number of observed signal-based values that fall outside the range of signal-based values to the number of pairs of data sets is above a threshold value.

4. The method of claim 2 wherein the signal-based value is a log ratio of signal values for the feature in a pair of data sets.

5. A method for normalizing a two or more microarray-derived data sets, the method comprising:
iteratively
selecting a normalizing set of features; and
computing a quality metric for the normalizing set of features by the method of claim 1;
until the quality metric calculated for the normalizing set of features falls within a range of quality-metric values specified as acceptable.

6. The method of claim 5 wherein selecting a normalizing set of features further includes selecting a normalizing set of features by a rank-consistency method using a current rank-consistency threshold of □and wherein the rank-consistency threshold □is initially set to a default value.

7. The method of claim 6 wherein, during each iteration of the method of claim 6, the rank-consistency threshold □is lowered to produce a more constrained set normalizing set of features.

8. The method of claim 5 wherein the quality metric calculated for the normalizing set of features falls within a range of quality-metric values specified as acceptable when the quality metric falls below a threshold quality-metric value.

9. A system, including one or more computer processors and a computer-readable memory, that normalizes microarray-derived data sets by the method of claim 5.

10. Computer instructions stored in a computer-readable memory that carry out the method of claim 5.

11. Transmitting to a remote location a result obtained using a method of claim 5.

12. Receiving from a remote location a result obtained using a method of claim 5.

13. A method for normalizing a two or more microarray-derived data sets, the method comprising:
partitioning features of the microarray-derived data sets into subsets of features; and
for each subset of features,
iteratively
selecting a normalizing set of features; and
computing a quality metric for the normalizing set of features by the method of claim 1;
until the quality metric calculated for the normalizing set of features falls within a range of quality-metric values specified as acceptable.

14. The method of claim 13 wherein partitioning features of the microarray-derived data sets into subsets of features further includes partitioning features of the microarray-derived data sets into subsets of features based on signal intensity of signals for the features in one or more data sets.

15. The method of claim 13 wherein selecting a normalizing set of features further includes selecting a normalizing set of features by a rank-consistency method using a current rank-consistency threshold of □and wherein the rank-consistency threshold □is initially set to a default value.

16. The method of claim 15 wherein, during each iteration of the method of claim 13, the rank-consistency threshold □is lowered to produce a more constrained set normalizing set of features.

17. The method of claim 13 wherein the quality metric calculated for the normalizing set of features falls within a range of quality-metric values specified as acceptable when the quality metric falls below a threshold quality-metric value.

18. A system, including one or more computer processors and a computer-readable memory, that normalizes microarray-derived data sets by the method of claim 13.

19. Computer instructions stored in a computer-readable memory that carry out the method of claim 13.

20. Transmitting to a remote location a result obtained using a method of claim 13.

21. Receiving from a remote location a result obtained using a method of claim 13.

22. A method for normalizing a two or more microarray-derived data sets, the method comprising:
receiving an initial set of normalizing features;
iteratively
computing a quality metric for the refined, set of normalizing features by the method of claim 1; and
when the quality metric is lower than a threshold quality metric, refining the set of normalizing features;
until the quality metric calculated for set of normalizing features is greater than or equal to a threshold quality-metric value.

23. The method of claim 22 wherein refining the normalizing set of features further includes selecting a subset of normalizing features from the set of normalizing features by a rank-consistency method using a current rank-consistency threshold of □and wherein the rank-consistency threshold □is initially set to a default value.

24. The method of claim 23 wherein, during each iteration of the method of claim 21, the rank-consistency threshold □is lowered to produce a more constrained set normalizing set of features.

25. The method of claim 22 wherein the quality metric calculated for the normalizing set of features falls within a range of quality-metric values specified as acceptable when the quality metric falls below a threshold quality-metric value.

26. A system, including one or more computer processors and a computer-readable memory, that normalizes microarray-derived data sets by the method of claim 22.

27. Computer instructions stored in a computer-readable memory that carry out the method of claim 22.

28. Transmitting to a remote location a result obtained using a method of claim 22.

29. Receiving from a remote location a result obtained using a method of claim 22.
